(19) United States
(12) Patent Application Publication
(10) Pub. No.: US 2010/0284122 A1
(43) Pub. Date: Nov. 11, 2010

(54) Electronic ignition device

(75) Inventors: Yuan-Chao Yang, Beijing (CN); Kai-li Jiang, Beijing (CN); Shou-Shan Fan, Beijing (CN)

Correspondence Address: Altis Law Group, Inc.;ATTN: Steven Reiss, 288 SOUTH MAYO AVENUE, CITY OF INDUSTRY, CA, 91789, US

(73) Assignees: Tsinghua University, Beijing City (CN); HON HAI Precision Industry CO., LTD., Tu-Cheng City (TW)

(21) Appl. No.: 12/590,292

(22) Filed: Nov. 5, 2009

(30) Foreign Application Priority Data
May 8, 2009 (CN) 200910107402.0

(51) Int. Cl. F23Q 3/00; H01T 13/20

(52) U.S. Cl. 361/260; 313/141

(57) ABSTRACT

An electronic ignition device includes a discharge electrode. The discharge electrode includes a carbon nanotube linear structure. The carbon nanotube linear structure includes at least one carbon nanotube at a free end thereof.

### CROSS-REFERENCE TO RELATED APPLICATIONS

This application claims all benefits accruing under 35 U.S.C. §119 from China Patent Application No. 200910107402.0, filed on May 8, 2009 in the China Intellectual Property Office, the disclosure of which is incorporated herein by reference. This application is related to copending application entitled, “OZONE GENERATOR”, filed ______ (Atty. Docket No. US24924).

### BACKGROUND

1. Technical Field

The present disclosure relates to ignition devices, particularly, to an electronic ignition device.

2. Description of Related Art

An electronic ignition device generally includes a discharge electrode, a target electrode, a power source, and a power switch. The target electrode is spaced from and opposite to the discharge electrode. The power source is used for forming a working voltage difference between the discharge electrode and the target electrode. The power switch is used to control on/off of the power source. A fuel is injected into a clearance between the discharge electrode and the electrode when the electronic ignition device is in use. The fuel is mixed with air and forms a gas medium. The discharge electrode has a discharge end with a small diameter, and then the discharge end can produce a plurality of charges thereby forming a strong electrical field thereon. A breakdown will occur when a strong electrical field difference exists in the clearance. The breakdown produces an electric spark. The electric spark can ignite the fuel mixed in the gas medium.

The above-described electronic ignition indicates that the electric spark is a main factor in igniting the fuel mixed in the gas medium. A strong electrical field is demanded in order to obtain the electric spark when the clearance between the discharge electrode and the electrode is a fixed value. In other words, the ignition device needs to adopt a power source with higher working voltage difference or a discharge end with a smaller diameter in order to ignite the fuel. It is very difficult to produce a metallic discharge end with a diameter smaller than 1 micrometer however, and most discharge ends are merely a metal thread. The ignition device generally adopts a power source with a relatively higher voltage. The power source with a higher working voltage difference makes the ignition device unsafe. Further, the power source with a higher working voltage difference is very expensive, increasing the cost of the ignition device.

What is needed, therefore, is to provide an ignition device having a discharge end with a relatively smaller diameter, whereby, the power source in the ignition device can have a relatively lower working voltage difference.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic structural view of an embodiment of an ignition device.

FIG. 2 shows a Scanning Electron Microscope (SEM) image of an untwisted carbon nanotube wire.

FIG. 3 shows an SEM image of a twisted carbon nanotube wire.

FIG. 4 shows an SEM image of broken-end portions of a carbon nanotube wire.

FIG. 5 shows a Transmission Electron Microscope (TEM) image of a broken-end portion of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

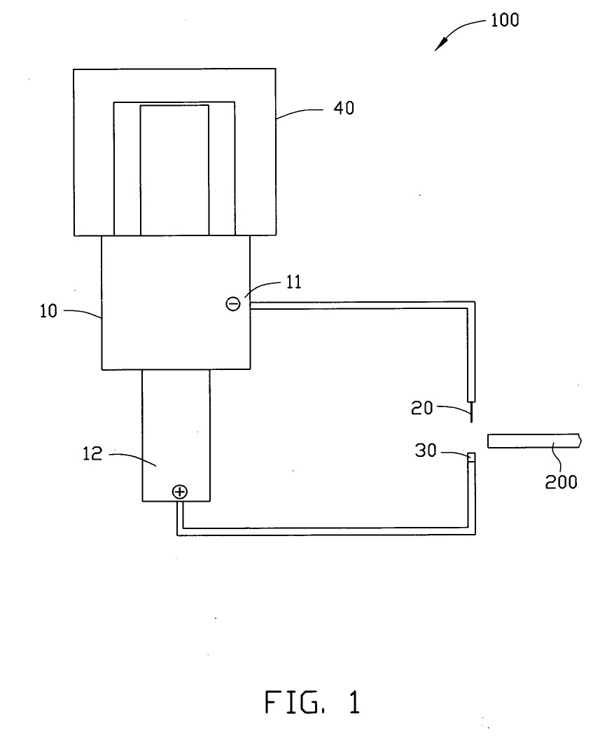

Referring to FIG. 1, an electronic ignition device 100 is used for igniting a fuel ejected from a fuel supply pipe 200. The fuel can be, for example, oil gas, natural gas, marsh gas, coal gas, or combinations thereof.

The electronic ignition device 100 includes a power source 10, a discharge electrode 20 electrically connected to the power source 10, a target electrode 30 spaced from and opposite to the discharge electrode 20, and an ignition switch 40. The fuel supply pipe 200 is configured to provide the fuel for the ignition device 100. The fuel is injected into a clearance between the discharge electrode 20 and the target electrode 30 from the fuel supply pipe 200. The fuel can be mixed with air to form a gas medium.

The power source 10 is configured to provide a working voltage difference between the discharge electrode 20 and the target electrode 30. The power source 10 can be made of piezoelectric ceramic. The power source 10 has a negative electrode 11 and a positive electrode 12. The negative electrode 11 is electrically connected to the discharge electrode 20. The positive electrode 12 is electrically connected to the target electrode 30. When mechanical force is used to apply a pressure to the power source 10, a pulse voltage can be produced between the negative electrode 11 and the positive electrode 12. Simultaneously, the working voltage difference having a same value as that of the pulse voltage will be formed between the discharge electrode 20 and the target electrode 30, such that a breakdown occurs in the gas medium between the discharge electrode 20 and the target electrode 30. An electric spark can be produced in the clearance by the breakdown. The electric spark ignites the fuel mixed in the gas medium.

The discharge electrode 20 can be electrically connected to the negative electrode 11 of the power source 10 by a conductive wire, and the conductive wire can be wrapped by an insulated layer. The smaller the clearance and the lower the breakdown voltage of the gas medium, the easier the electric spark is produced.

The discharge electrode 20 or the target electrode 30 can be easily damaged by a burning of the fuel due to the electric spark, when the distance of the clearance is too short. Thus, generally, the clearance is set to be about 1 micron to 2 millimeters.

The discharge electrode 20 includes a carbon nanotube linear structure having a diameter of about 0.4 nanometers to about 1 millimeter. The carbon nanotube linear structure can include a carbon nanotube wire and/or a carbon nanotube cable.

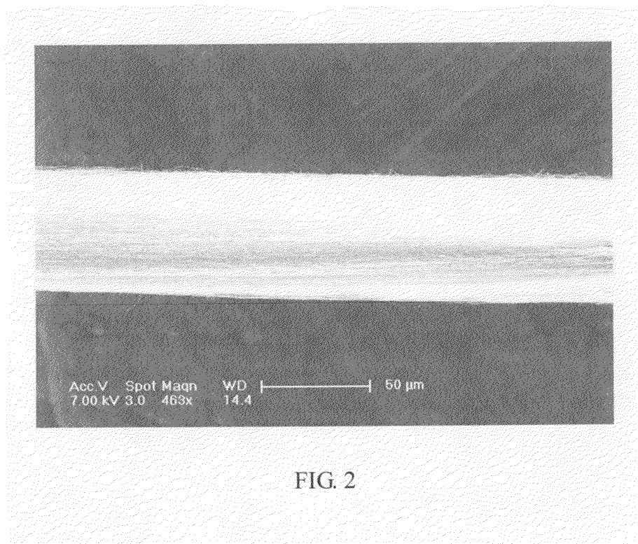

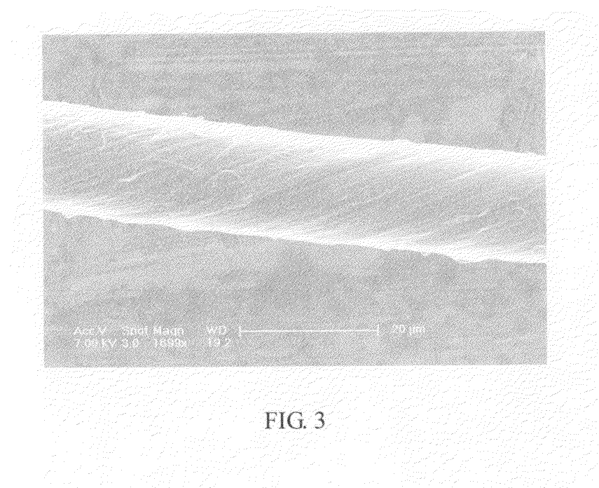

The carbon nanotube wire can be untwisted or twisted. Referring to FIG. 2, the untwisted carbon nanotube wire includes a plurality of carbon nanotubes substantially oriented along a same direction (i.e., a direction along the length of the untwisted carbon nanotube wire). The carbon nanotubes are parallel to an axis of the untwisted carbon nanotube wire. More specifically, the untwisted carbon nanotube wire includes a plurality of successive carbon nanotube segments joined end-to-end by van der Waals attractive force therebetween. Each carbon nanotube segment includes a plurality of carbon nanotubes substantially parallel to each other, and combined by van der Waals attractive force therebetween. The carbon nanotube segments can vary in width, thickness, uniformity and shape. Length of the untwisted carbon nanotube wire can be arbitrarily set as desired. A diameter of the untwisted carbon nanotube wire ranges from about 0.4 nanometers to about 100 micrometers. Referring to FIG. 3, the twisted carbon nanotube wire includes a plurality of carbon nanotubes helically oriented around an axial direction of the twisted carbon nanotube wire. More specifically, the twisted carbon nanotube wire includes a plurality of successive carbon nanotube segments joined end to end by van der Waals attractive force therebetween. Each carbon nanotube segment includes a plurality of carbon nanotubes parallel to each other, and combined by van der Waals attractive force therebetween. Length of the carbon nanotube wire can be set as desired. A diameter of the twisted carbon nanotube wire can be from about 0.4 nanometers to about 100 micrometers.

The carbon nanotube cable includes two or more carbon nanotube wires. The carbon nanotube wires in the carbon nanotube cable can be, twisted or untwisted. In an untwisted carbon nanotube cable, the carbon nanotube wires are parallel with each other. In a twisted carbon nanotube cable, the carbon nanotube wires are twisted with each other.

The carbon nanotube linear structure has a free end. The free end includes at least one carbon nanotube. The carbon nanotube can act as a discharge end of the discharge electrode 20 and has a diameter less than 50 nanometers. The free end of the carbon nanotube linear structure can include a plurality of carbon nanotubes combined each other by van der Waals attractive force therebetween. Each of the carbon nanotubes of the carbon nanotube linear structure can act as the discharge end of the discharge electrode 20. The discharge end can produce a plurality of charges thereby obtaining a strong electrical field thereon at a relatively low working voltage difference. Simultaneously, the gas breakdown in the clearance will occur at a relatively lower working voltage difference, because of the strong electrical field, by using the carbon nanotube linear structure as the discharge electrode 20. The electric spark is easily produced, because the power source 10 has a relatively lower working voltage difference; and the clearance is relatively larger. Thus, the carbon nanotube linear structure can enhance the reliability of the electronic ignition device 100.

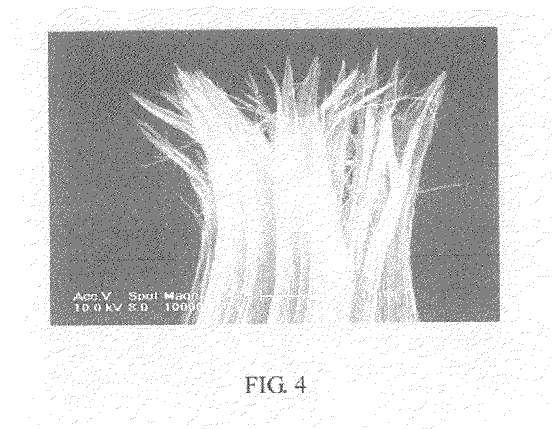

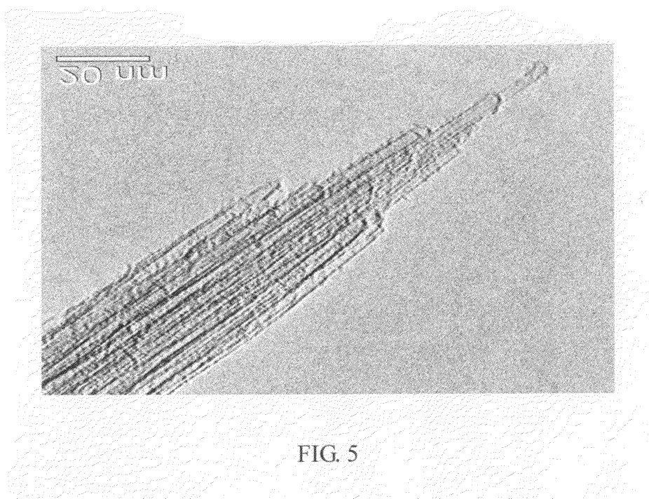

In one embodiment, the carbon nanotube linear structure has a broken-end portion close to the target electrode 30. The broken-end portion can be formed by melting the carbon nanotube linear structure, by ablating the carbon nanotube linear structure with a laser, or by scanning the carbon nanotube linear structure with an electron beam. The broken-end portion includes at least one taper-shaped structure. The at least one carbon nanotube protrudes from the at least one taper-shaped structure. The at least one taper-shaped structure includes a plurality of oriented carbon nanotubes. The at least one carbon nanotube is closer to the target electrode 30 than the other adjacent carbon nanotubes. Moreover, the taper-shaped structure of the at least one taper-shaped structure helps prevent the shield effect caused by the adjacent carbon nanotubes. The carbon nanotubes are parallel to each other, and are combined with each other by van der Waals attractive force. The at least one carbon nanotube can bear relatively higher working voltage differences since the protruding carbon nanotube is fixed by the adjacent carbon nanotubes by van der Waals attractive force. Referring to FIG. 4, in one embodiment, the broken-end portion includes a plurality of taper-shaped structures. Each of the taper-shaped structures includes a plurality of oriented carbon nanotubes. The carbon nanotubes are parallel to each other, and are combined with each other by van der Waals attractive force. The at least one carbon nanotube protrudes from the parallel carbon nanotubes in each taper-shaped structure. Referring to FIG. 5, in one embodiment, the at least one carbon nanotube includes a plurality of carbon nanotubes, and one of the carbon nanotubes protrudes from each taper-shaped structure. Additionally, there can be a gap between tops of the two adjacent taper-shaped structures. That can prevent the shield effect caused by the adjacent taper-shaped structures.

Alternatively, the surface of the carbon nanotube linear structure can also be coated with a metallic carbide layer or have a plurality of metallic carbide particles thereon. In one embodiment, each of the carbon nanotubes in the carbon nanotube linear structure is coated with the metallic carbide layer or a plurality of metallic carbide particles. The metallic carbide layer or metallic carbide particles have an extremely high melting point, relatively low work function, chemical inertness, and is resistive to ion bombardment. Thus, the metallic carbide layer or metallic carbide particles help prevent the carbon nanotubes from being impacted by ions, and can prolong a lifespan of the carbon nanotube linear structure. The metallic carbide can be hafnium carbide (HfC), zirconium carbide (ZrC), titanium carbide (TiC), columbium carbide (NbC), or combinations thereof. In one embodiment, the metallic carbide is HfC. The method for disposing the metallic carbide layer onto the carbon nanotube linear can include: forming a metal layer coating on the at least one carbon nanotube of the carbon nanotube linear structure; melting the metal layer coating by electrifying the carbon nanotube structure in a vacuum, thereby achieving a plurality of metallic carbide particles formed on the carbon nanotube due to a chemical reaction between the carbon atoms in the carbon nanotube and the melted metal layer.

The target electrode 30 can be a metal electrode and be electrically connected to the positive electrode 12 of the power source 10. The target electrode 30 can also be a hollow metal pipe connected to the fuel supply pipe 200.

The ignition switch 40 is configured for the on-off control of the power source 10 to form a working voltage difference between the discharge electrode 20 and the target electrode 30. In one embodiment, the ignition switch 40 is a pressure device configured for pressing the power source 10. A deformation will arise on the piezoelectric ceramic when the power source 10 is pressed by the ignition switch 40. A plurality of charges appears in the piezoelectric ceramic to form the pulse voltage or the working voltage difference. The ignition switch 40 can also be a pushbutton configured for switching on the power source 10. A plurality of charges is discharged from the electric pulse igniter to form the working voltage difference, when the ignition switch 40 is pressed by a mechanical force.

Finally, it is to be understood that the above-described embodiments are intended to illustrate rather than limit the disclosure. Variations may be made to the embodiments without departing from the spirit of the disclosure as claimed. Elements associated with any of the above embodiments are envisioned to be associated with any other embodiments. The above-described embodiments illustrate the scope of the disclosure but do not restrict the scope of the disclosure.

What is claimed is:

1. An electronic ignition device comprising:
a discharge electrode comprising a carbon nanotube linear structure, the carbon nanotube linear structure comprising at least one carbon nanotube extending from an free end thereof; and
a target electrode;
a power source capable of applying a voltage difference between the target electrode and the discharge electrode.

2. The electronic ignition device of claim 1, wherein the discharge electrode and the target electrode are capable of igniting a gas medium located therebetween, wherein the gas medium comprises of fuel.

3. The electronic ignition device of claim 1, wherein the carbon nanotube linear structure has a diameter of about 0.4 nanometers to about 1 millimeter.

4. The electronic ignition device of claim 1, wherein the carbon nanotube linear structure comprises at least one carbon nanotube wire, the at least one carbon nanotube wire comprises a plurality of successive carbon nanotube segments joined end-to-end by van der Waals attractive force therebetween, each of the carbon nanotube segments comprises a plurality of carbon nanotubes parallel to each other, and combined by van der Waals attractive force therebetween.

5. The electronic ignition device of claim 4, wherein the at least one carbon nanotube wire comprises the plurality of carbon nanotubes substantially oriented along a same direction, the carbon nanotubes are substantially parallel to an axis of the at least one carbon nanotube wire.

6. The electronic ignition device of claim 4, wherein the at least one carbon nanotube wire comprises the plurality of carbon nanotubes helically oriented around an axial direction of the carbon nanotube wire.

7. The electronic ignition device of claim 4, wherein the carbon nanotube linear structure comprises two or more carbon nanotube wires, the carbon nanotube wires are parallel with each other.

8. The electronic ignition device of claim 4, wherein the carbon nanotube linear structure comprises two or more carbon nanotube wires, the carbon nanotube wires are twisted with each other.

9. The electronic ignition device of claim 4, wherein a diameter of the at least one carbon nanotube wire ranges from about 0.4 nanometers to about 100 micrometers.

10. The electronic ignition device of claim 1, wherein each carbon nanotube ranges from about 0.4 nanometers to about 100 nanometers.

11. The electronic ignition device of claim 1, wherein the carbon nanotube linear structure comprises a broken-end portion, the broken-end portion comprises at least one taper-shaped structure, the at least one carbon nanotube protrudes from the at least one taper-shaped structure.

12. The electronic ignition device of claim 11, wherein the at least one taper-shaped structure comprises a plurality of carbon nanotubes substantially oriented along a same direction, the carbon nanotubes are parallel to each other, and are combined to each other by van der Waals attractive force between, the at least one carbon nanotube protrudes from the plurality of carbon nanotubes in the at least one taper-shaped structure.

13. The electronic ignition device of claim 12, wherein there is only one carbon nanotube that protrudes from the plurality of carbon nanotubes in the at least one taper-shaped structure.

14. The electronic ignition device of claim 1, wherein the carbon nanotube linear structure comprises of metallic carbide.

15. The electronic ignition device of claim 1, wherein a plurality of metallic carbide particles are located on the carbon nanotube linear structure.

16. The electronic ignition device of claim 1, wherein the power source is a piezoelectric ceramic power source.

17. The electronic ignition device of claim 1, wherein a distance of the clearance ranges from about 2 micrometers to about 10 millimeters.

18. An electronic ignition device, comprising:
a discharge electrode comprising a carbon nanotube linear structure having a discharge end, the discharge end comprising a plurality of carbon nanotubes, wherein a diameter of the carbon nanotube ranges from about 0.4 nanometers to about 100 nanometers; and
a target electrode;
a power source comprising a negative electrode and a positive electrode, wherein the negative electrode is electrically connected to the discharge electrode, the positive electrode is electrically connected to the target electrode, a distance of a clearance between the discharge electrode and the target electrode ranges form about 2 micrometers to about 10 millimeters.

19. The electronic ignition device of claim 18, wherein there is a single carbon nanotube that protrudes from other carbon nanotubes at the discharge end.

20. The electronic ignition device of claim 19, wherein the discharge end has a tapered configuration.
